(19) United States
(12) Patent Application Publication
(10) Pub. No.: US 2014/0159880 A1
(43) Pub. Date: Jun. 12, 2014

(54) HANDHELD ELECTRONIC DEVICE AND CONTROL METHOD

(71) Applicant: Hon Hai Precision Industry Co., Ltd., New Taipei (TW)

(72) Inventors: CHIH-CHUN CHANG, New Taipei (TW); CHUN-HUNG LAI, New Taipei (TW); KUN-HAO HSU, New Taipei (TW)

(73) Assignee: HON HAI PRECISION INDUSTRY CO., LTD., New Taipei (TW)

(21) Appl. No.: 13/960,845

(22) Filed: Aug. 7, 2013

(30) Foreign Application Priority Data
Dec. 10, 2012 (TW) 101146464

(51) Int. Cl. G08C 19/16

(52) U.S. Cl. CPC G08C 19/16
USPC 340/12.54

(57) ABSTRACT

A control method is applied to a handheld electronic device. The handheld electronic device comprising a display module, and a back light to drive the display module, the display module displaying information and sensing touches on the display module; the control method includes steps of: generating a power saving instruction in response to a user's command; turning off the backlight in response to the power saving instruction; determining whether an operation occurs; determining whether the operation is a predetermined operation and generating a control instruction to manipulate a household electronic device when the operation is the predetermined operation.

### BACKGROUND

1. Technical Field

The disclosure relates to handheld electronic devices, and particularly to a handheld electronic device and control method for manipulating a household electronic device.

2. Description of Related Art

Most household electronic devices, such as a television, a fridge, an air condition, are manipulated by remote controls. Nowadays, handheld electronic devices, such as a mobile phone, a personal digital assistant (PDA), function as the remote control for manipulating the household electronic device. However, when the handheld electronic device manipulates the household electronic device, a menu is always displayed on the handheld electronic device to be operated for controlling the household electronic devices. Thus, displaying the menu depletes the battery energy and this is an inconvenience.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a handheld electronic device manipulating a household electronic device in accordance with an embodiment.

FIG. 2 is a function block diagram of the handheld electronic device in FIG. 1, the handheld electronic device comprises a remote control system and a storage.

FIG. 3 is a system menu provided by the handheld electronic device in FIG. 2.

FIG. 4 is function block diagram of the remote control system of the handheld electronic device in FIG. 2.

FIG. 5 shows content stored in the storage in FIG. 2.

FIG. 6 is a control menu provided by the handheld electronic device in FIG. 2.

FIG. 7 is a flowchart of a control method in accordance with an embodiment.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

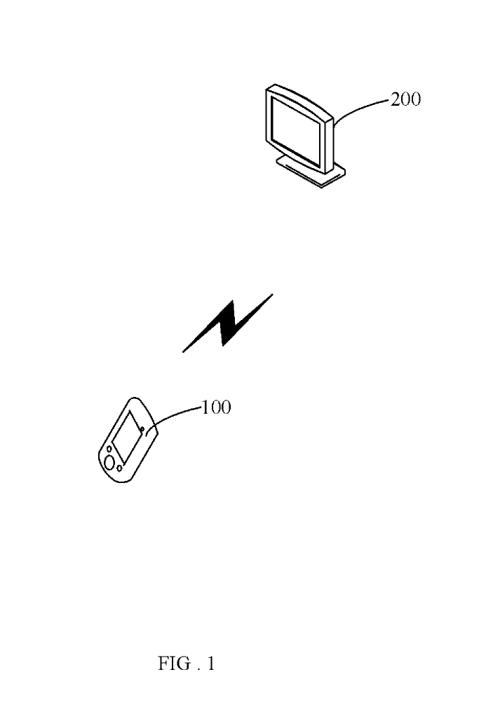

FIG. 1 shows a handheld electronic device 100 of an embodiment manipulating a household device 200. The handheld electronic device 100 may be a mobile phone, a personal digital assistant (PDA), a palm computer, for example. The household electronic device 200 may be a TV, a fridge, an air conditioner, for example. In this embodiment, the handheld electronic device 100 is a mobile phone. The household electronic device is a TV. The handheld electronic device 100 communicates with the household electronic device 200 via known wireless technologies, such as an infra-red (IR) technology, a wireless fidelity (WI-FI) technology, a (radio frequency) RF technology, for example.

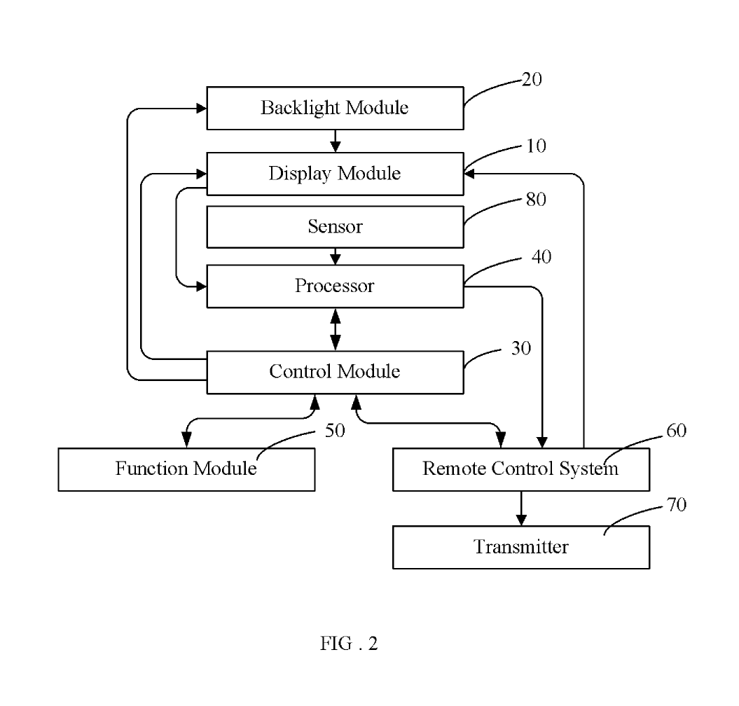

FIG. 2 shows a functional block diagram of the handheld electronic device 100 of an embodiment. The handheld electronic device 100 includes a remote control system 60. The handheld electronic device 100 further includes a display module 10, a backlight module 20, a control module 30, a processor 40, a number of function modules 50, a transmitter 70, and a senor 80. FIG. 2 illustrates only one example of the handheld electronic device 100 that may include more or fewer components than illustrated, or have a different configuration of the various components.

Each function module 50 is configured to perform one particular function, such as a calling function, SMS sending function, an audio playing function, a video playing function, a computing function, for example.

The backlight module 20 emits light to drive the display module 10.

The display module 10 is a touch panel that not only displays information, but also senses touches on the touch panel.

The sensor 80 detects motions of the handheld electronic device 100.

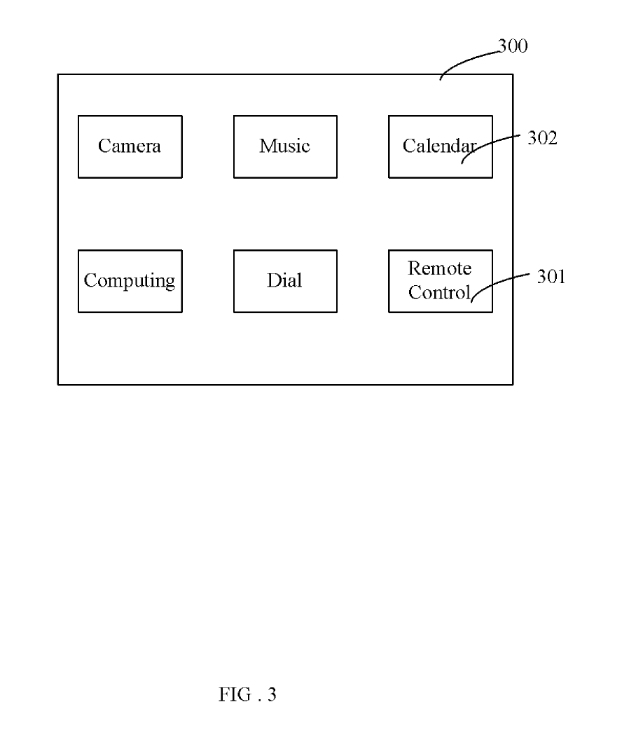

In this embodiment, when the handheld electronic device 100 is started up, the control module 30 provides a system menu 300 to display on the display module 10 (see FIG. 3). The system menu 300 includes a remote control icon 301 associated with the remote control system 60, and a number of function icons 302 associated with the function modules 50.

When the remote control icon 301 is clicked, the processor 40 generates a start instruction. When the function icon 302 is clicked, the processor 40 generates a calling instruction.

In response to the calling instruction, the control module 30 controls the corresponding function module 50 to perform the corresponding function.

Furthermore, in response to the start instruction, the control module 30 controls the remote control system 60 to control the handheld electronic device 100 to enter into a remote mode of manipulating the household electronic device 100.

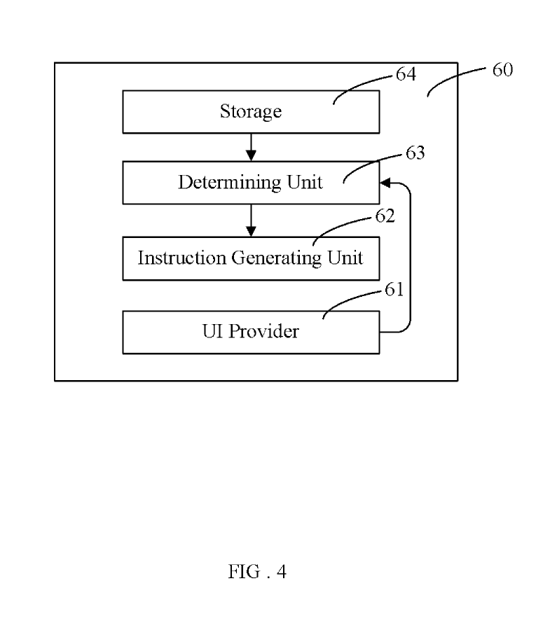

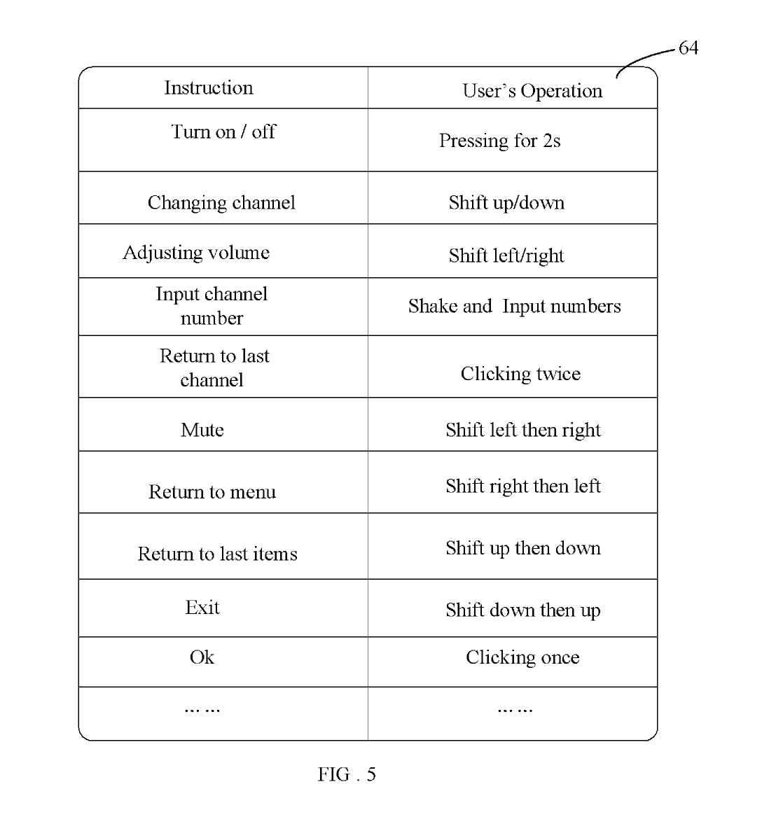

FIG. 4 shows a function block diagram of the remote control system 60. The remote control system 60 includes a user interface (UI) provider 61, an instruction generating unit 62, a determining unit 63, and a storage unit 64. The storage unit 64 stores a number of operations and a number of control instructions associated with the operations. The operations include, but not limited to, touches on the display module 10 or/and the motions of the handheld electronic device 100. When one of the stored operations occurs, the control instructions associated with the operation is generated to manipulate the household electronic device 200. See FIG. 5, for several examples, when the user presses on the display module 10 for 2 s, a control instruction for controlling the household electronic device 200 to turn on or turn off is generated. When the touches on the display module 10 shift up and down, a control instruction for controlling the household electronic device 200 to change channels up and down is generated. When the touches on the display module 10 shifts right and left, a control instruction for controlling the household electronic device 200 to lower and raise the volume is generated. When the handheld electronic device 100 is shook a number is written on the display module 10, a control instruction for inputting a channel number into the household electronic device 200 is generated.

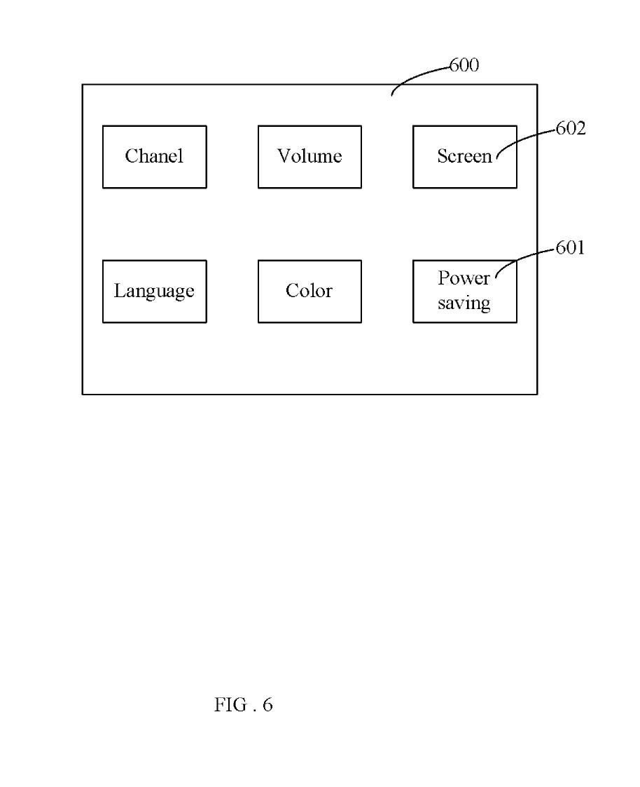

FIG. 6 shows that the UI provider 61 provides a remote control menu 601 to display on the display module 10 in response to the start instruction. The remote control menu 601 includes a power saving icon 601 and a number of control icons 602 associated with the control instructions. When the control icon 602 is clicked, the instruction generating unit 61 generates the control instructions associated with the clicked control icon 602, and transmits the control instruction to the household electronic device 200 to manipulate the household electronic device 200. When the power saving icon 601 is clicked, the instruction generating unit 61 generates a power saving instruction.

The control module 30 is further configured to turn off the backlight module 20 to cause the handheld electronic device 100 to enter into the power saving mode. After the handheld electronic device 100 enters into the power saving mode, and the display module 10 detects a touch on or a motion of the handheld electronic device 100 is detected by the sensor 80, the processor 40 generates input signals.

The determining unit 63 is configured to determine whether the operation is a predetermined operation in response to the input signals. In detail, the determining unit 63 compares the operation with the stored operations, and generates a determining signal when the operation is one of the stored operations.

The instruction generating unit 62 generates the control instructions associated with the operation in response to the determining signal.

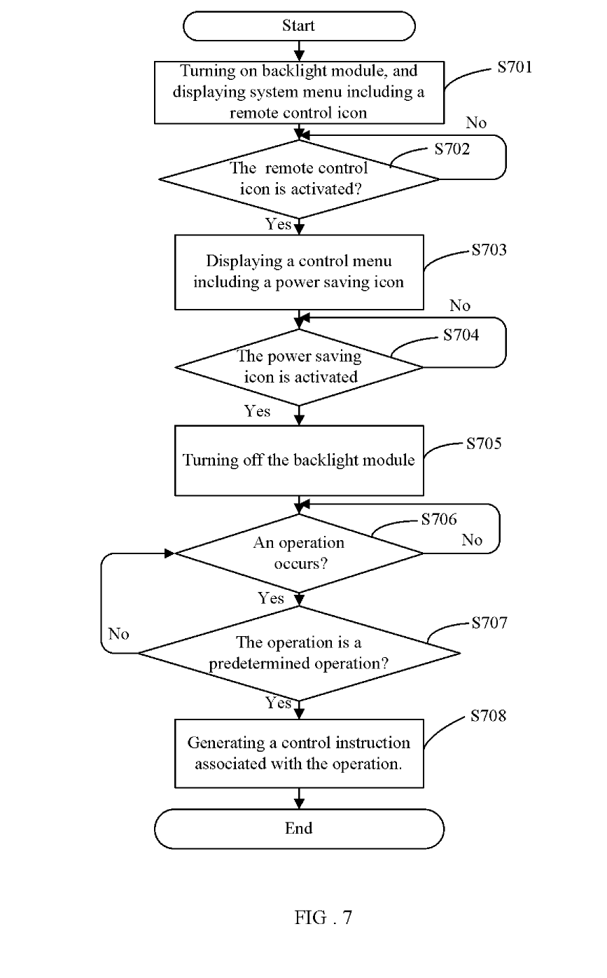

FIG. 7 shows a flowchart of a controlling method applied to the electronic device 100 to control the household electronic device 200.

In step S701, the control module 30 controls the backlight module 20 to turn on and provides a system menu 300 including a remote control icon 301 to display on the display module 10.

In step S702, the processor 40 determines whether the remote control icon 301 is activated. If the remote control icon 301 is activated, the process goes to step S703 otherwise step S702 is repeated.

In step S703, when the remote control icon 301 is activated, the UI provider 61 provides a control menu including a power saving icon 601 and a number of control icons 602.

In step S704, the processor 40 determines whether the power saving icon 601 is activated. If the power saving icon 601 is activated the process goes to step S705 otherwise step S704 is repeated.

In step S705, the control module 30 controls the backlight module 20 to turn off so that the handheld electronic device 100 enters into the power saving mode.

In step S706, the processor 40 determines whether an operation occurs. If the operation occurs, the process goes to step S707 otherwise step S706 is repeated.

In step S707, the determining unit 63 determines whether the operation is a predetermined operation. In detail, the determining unit 63 compares the operation with stored operations, when the operation is one of the stored operations, the determining unit 63 determines that the operation is the predetermined operation, and the process goes to step S708 otherwise the process returns to step S707.

In step S708, the instruction generating unit 62 generates the control instruction associated with the operation, and the transmitter 70 transmits the control instruction to the household electronic device 200 to manipulate the household electronic device 200.

As described above, the handheld electronic device 100 turns off the backlight module 20 to enter into the power saving mode to control the household electronic device 200. Thus, the energy in the battery of the handheld electronic device 100 in the remote control is conserved.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A handheld electronic device, for manipulating a household electronic device, the handheld electronic device comprising:
a display module with a touch panel to sense a touch on the display module;
a back light module to be turned on to drive the display module;
a processor generating a power saving instruction in response to a user's command;
a control module to control the backlight to turn off in response to the power saving instruction;
a remote control system to generate a control instruction; and
a transmitter to transmit the control instruction to the household electronic device to manipulate the household electronic device;
wherein after the backlight module is turned off, the processor determines whether a user' operation occurs and generates an input signal when the operation occurs; the remote control system determines whether the operation is a predetermined operation in response to the input signal, and generates the control instruction when the operation is the predetermined operation.

2. The handheld electronic device of claim 1, wherein the remote control system comprises a storage, a determining unit, and an instruction generating unit, the storage stores a plurality of operations and a plurality of control instructions associated with the operations, the determining unit compares the operation with the stored operations to determine whether the operation is the predetermined operation, and generates a determining signal when the operation is one of the stored operation; the instruction unit generates the control instruction associated with the operation in response to the determining signal.

3. The handheld electronic device of claim 1, wherein the handheld electronic device further comprises a sensor to sense motions of the handheld electronic device, and generate motion signals; when the handheld electronic device is in the power saving mode, the processor determines that the operation occurs in response to the motion signal; the remote control system determines whether the operation is the predetermined operation, and generates the control instruction when the operation is the predetermined operation.

4. The handheld electronic device of claim 1, wherein the control module provides a system menu to display on the display module when the handheld electronic device is turned on, the system menu comprises a control icon associated with the remote control system, and the control icon is activated to generate a remote control instruction to start up the remote control system.

5. The handheld electronic device of claim 4, wherein the remote control system further comprises a user interface provider, the user interface provider provides a control menu to display on the display module in response to the remote control instruction, the control menu comprises a power saving icon, the power saving icon is activated to generate the power saving instruction.

6. A control method applied to a handheld electronic device, the handheld electronic device comprising a display module, and a back light to drive the display module, the display module displaying information and sensing a touch on the display module; the control method comprising:
generating a power saving instruction in response to a user's command;
turning off the backlight in response to the power saving instruction;
determining whether an operation occurs;
determining whether the operation is a predetermined operation when the operation occurs; and
generating a control instruction to manipulate a household electronic device when the operation is the predetermined operation.

7. The control method of claim 6, wherein the control method further comprises:
storing a plurality of operations, and a plurality of control instructions associated with the operations, and determining whether the operation is the predetermined operation by comparing the operation with the stored operations, and when the operation is the stored operation.

8. The control method of claim 6, wherein after the step of turning off the backlight, the control method further comprises:
sensing whether a motion of the handheld electronic device occurs by a sensor setting on the handheld electronic device; determining whether the motion of the handheld electronic device is the predetermined operation when the motion of the handheld electronic device occurs; and
generating the control instruction when the motion of the handheld electronic device is the predetermined operation.

9. The control method of claim 6, wherein the step of generating a power saving instruction in response to a user's command comprises:
displaying a system menu on the display module, the system menu comprising a control icon associated with the remote control system;
determining whether the control icon is activated;
displaying a control menu, the control menu comprising a power saving icon associated with remote control instruction when the control icon is activated;
determining whether the power saving icon is activated; and
generating the remote control instruction when the power saving icon is activated.
